(19) United States
(12) Patent Application Publication
(10) Pub. No.: US 2005/0286614 A1
(43) Pub. Date: Dec. 29, 2005

(54) Carrier frequency offset detecting apparatus in a digital receiver system and a method thereof

(76) Inventor: Jung-won Kwak, Seoul (KR)

Correspondence Address: STANZIONE & KIM, LLP, 919 18TH STREET, N.W., SUITE 440, WASHINGTON, DC, 20006, US

(21) Appl. No.: 11/155,549

(22) Filed: Jun. 20, 2005

(30) Foreign Application Priority Data
Jun. 23, 2004 (KR) 2004-47147

(51) Int. Cl. H04B 1/707

(52) U.S. Cl. 375/150; 375/343

(57) ABSTRACT

A carrier frequency offset detecting apparatus of a digital receiver and a carrier frequency offset detecting method thereof. The carrier frequency offset detecting apparatus includes correlators to calculate individual correlation values by employing pseudo-noise sequences; at least one conjugate signal generation unit to generate a conjugate complex number for each of the correlation values; at least one multiplier to multiply the individual conjugate complex numbers with the individual correlation values of the neighbored correlators; an adder to add the multiplied values; and a phase extractor to extract a phase component from an output value of the adder and output the phase component as a carrier frequency offset. Therefore, the carrier frequency offset is detected even in case that a pilot signal cannot be employed because of a poor channel environment.

### CROSS-REFERENCE TO RELATED APPLICATIONS

This application claims the benefit of Korean Patent Application No. 2004-47147 filed on Jun. 23, 2004, in the Korean Intellectual Property Office, the disclosure of which is incorporated herein by reference in its entirety.

### BACKGROUND OF THE INVENTION

1. Field of the Invention

The present general inventive concept relates to a digital receiver system. More particularly, the present general inventive concept relates to a carrier frequency offset detecting apparatus in a digital receiver system, and a detecting method thereof.

2. Description of the Related Art

In a vestigial sideband (VSB) transmission mode which is one of several digital signal transmission modes, a pilot tone is inserted into a frequency domain of a VSB signal, and a receiver performs a timing recovery and a carrier recovery by using this inserted pilot tone.

FIG. 1 is a diagram illustrating a waveform of a frequency of a VSB signal frequency. As illustrated in FIG. 1, the pilot tone is generated by inserting a direct current (DC) component of a uniform level into a low band edge side of 300 KHz in a baseband signal. Therefore, a receiver accurately recovers a locus of the pilot tone in a frequency domain of the received signal and converts the pilot tone into the DC component. With use of these recovery and transformation operations, the receiver is capable of performing a timing recovery and a carrier recovery through correcting an error in the carrier.

Also, the receiver is capable of compensating a carrier frequency offset by extracting the pilot tone inserted into the received signal using a carrier frequency recovery circuit, such as a frequency phase locked loop (FPLL).

FIG. 2 is a block diagram illustrating a typical carrier frequency offset recovery circuit. This carrier frequency offset recovery circuit is a type of a digital frequency phase locked loop (DFPLL) and comprises an automatic frequency control low pass filter (AFC LPF) 10 for detecting a frequency offset, an automatic phase control low pass filter (APC LPF) 40 for detecting a phase error and a voltage controlled oscillator (VOC) 50 for correcting a carrier error of the received signal. Also, the carrier frequency offset recovery circuit performs a carrier recovery interlocked with a timing recovery by using the pilot tone.

FIG. 3 illustrates diagrams of a relationship between a frequency error and a waveform of an input signal of the AFC LPF 10 illustrated in FIG. 2.

If a frequency error of an input signal is a positive value, the AFC LPF 10 changes a phase of the input signal by −90°. Conversely, if the frequency error of the input signal is a negative value, the AFC LPF 10 changes the phase of the input signal by +90°. Also, as shown in the third waveform from the left side, for an input of a sine wave to an imaginary part (I) and a real part (Q), the change in the phase of the input signal of the AFC LPF 10 is determined by the frequency error. Hence, a low-pass filtering is carried out at the AFC LPF 10, so that an output signal has a DC component in proportion to the frequency error.

As a result of the DC component acquisition, the VCO 50 increases a free drive frequency value by an amount of the DC component proportional to the frequency error, and the frequency value output from the VOC is then multiplied with signals respectively from the imaginary part (I) and from the real part (Q) of the original input signal of the carrier frequency recovery circuit through the use of multipliers 70 and 80, thereby correcting the frequency error. After the correction of the frequency error, a phase correction is carried out in accordance with a phase characteristic of an output value of the APC LPF 40 illustrated in FIG. 2

FIG. 4 illustrates a phase characteristic of an output value of the APC LPF illustrated in FIG. 2. As illustrated, a phase error detected by the APC LPF 40 has equilibrium points at 90° and at 270°. Therefore, a demodulated signal can have an inverted polarity.

The above described carrier frequency recovery method using the pilot tone provides an adequate performance result in case that the pilot tone is completely recovered. However, there may be a problem that the carrier frequency cannot be recovered when the pilot tone is damaged due to poor channel environments caused by several factors such as a multipath generated at a transmission channel. Also, when an intention is to broaden a compensation range of the carrier frequency offset, an amount of a remaining offset after the compensation may still be high, and if it is intended to decrease the amount of the remaining offset, the compensation range may be narrowed.

### SUMMARY OF THE INVENTION

Accordingly, the present general inventive concept provides a carrier frequency offset detecting apparatus to detect a carrier frequency offset regardless of a symbol timing offset by using a cross correlation value with a non-coherent channel profile in a digital receiver system, and a carrier frequency offset detecting method thereof.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an apparatus to detect a carrier frequency offset, including a plurality of correlators to calculate individual correlation values by employing pseudo-noise (PN) sequences classified into a predetermined number of sub-sequences with respect to an input signal; at least one conjugate signal generation unit to input individual output values of the correlators and then to generate a conjugate complex number for each of the input values; at least one multiplier to multiply the individual conjugate complex numbers output from the at least one conjugate signal generation unit with the individual output values of the correlators that do not input the correlation values to the at least one conjugate signal generation unit; an adder to add output values of at least one multiplier; and a phase extractor to extract a phase component from an output value of the adder and to output the phase component as a carrier frequency offset.

The output value of the adder can be defined in accordance with an equation as

$${\sum }_{i = 1}^{N - 1} {\sum }_{n = 1}^{K} {r}_{i}^{*} {p}_{i} ( n ) {r}_{i + 1} ( n ) {P}_{i + 1} ( n ) ,$$

where r(n) is an input signal and p(n) is the PN sequence classified into the predetermined number of sub-sequences.

Also, the input signal can be defined as follows
rᵢ(n)=pᵢ(n)e^{j(θ}^{₀}^{+((i-1)K+n)θ)}+nᵢ(n)

The plurality of correlators can calculate the correlation values by using the predetermined number of sub-sequences classified from the PN sequences and defined in accordance with an equation as
p(n)=(p₁(n₁), p₂(n₂), . . . , pₙ(n_{N})
1≦n≦M
1≦nᵢ≦K(i=1, 2, . . . , N)
where p(n) is the PN subsequence classified into the predetermined number of sub-sequences.

The phase component extracted from the phase extractor can be defined in accordance with an equation as:

$${\sum }_{i = 1}^{N} \vert {\sum }_{n = 1}^{K} {r}_{i} ( k ) {p}_{i} ( k ) \vert ,$$

where CFO is the carrier frequency offset.

The phase extractor can also extract the phase component from a vector summation of the output values of the adder for paths exceeding a predetermined threshold value by employing a channel profile based on a non-coherent correlation value obtained by using the correlation values outputted from the plurality of correlators.

The phase extractor can extract the phase component from the output value of the adder corresponding to a main path by employing a channel profile based on a non-coherent correlation value obtained by using the correlation values output from the plurality of correlators.

The non-coherent correlation value can be defined in accordance with an equation as

$$CFO = ∠ [ {\sum }_{i = 1}^{N - 1} {\sum }_{n = 1}^{K} {r}_{i}^{*} ( n ) {p}_{i} ( n ) {r}_{i + 1} ( n ) {P}_{i + 1} ( n ) ] ,$$

where p(k) is the PN sequence classified into the predetermined number of sub-sequences and r(k) is the input signal.

The foregoing and/or other aspects and advantages of the present general inventive concept may also be achieved by providing a method of detecting a carrier frequency offset, including calculating individual correlation values by employing PN sequences classified into a predetermined number of sub-sequences with respect to an input signal; generating individual conjugate complex numbers for the individual correlation values output from distally disposed parts among the calculated correlation values; multiplying the individual conjugate complex numbers with the individual correlation values outputted from proximally disposed parts among the calculated correlation values; adding the multiplied values, thereby obtaining a cross correlation value; and extracting a phase component from the cross correlation value and outputting the phase component as a carrier frequency offset.

Accordingly, the carrier frequency offset can be detected even when a pilot signal cannot be detected due to a poor channel environment.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating a waveform of a vestigial sideband signal frequency;

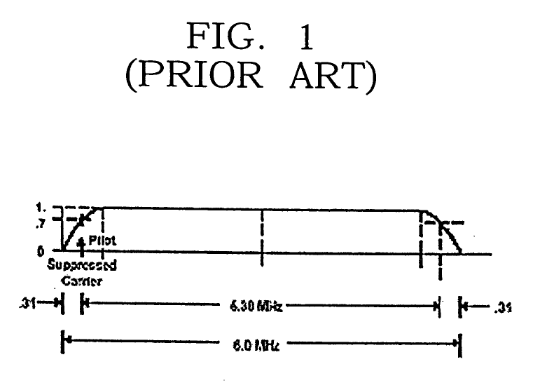

FIG. 2 is a block diagram illustrating a typical carrier frequency offset recovery circuit;

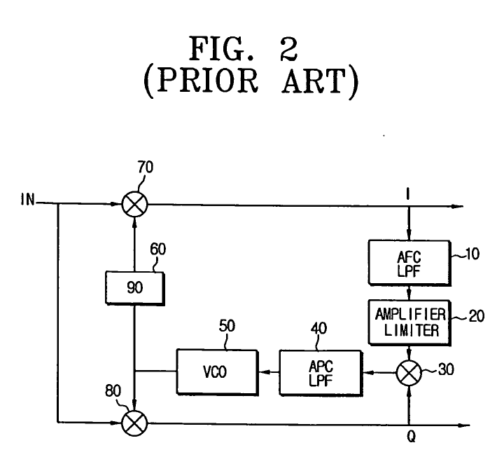

FIG. 3 illustrates diagrams of a relationship between a frequency error and an input waveform of an automatic phase control low pass filter (APC LPF) illustrated in FIG. 2;

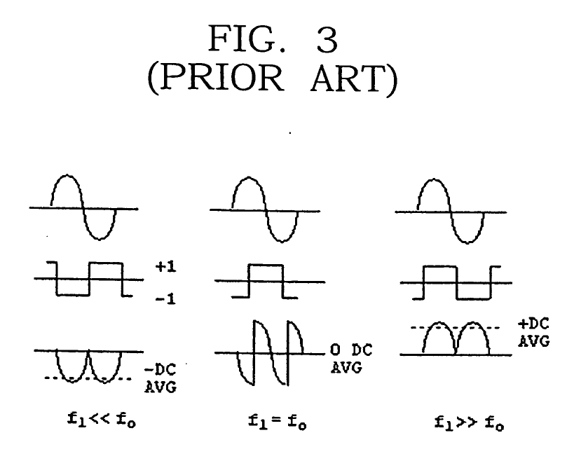

FIG. 4 is a diagram illustrating a phase characteristic of an output value of the APC LPF illustrated in FIG. 2;

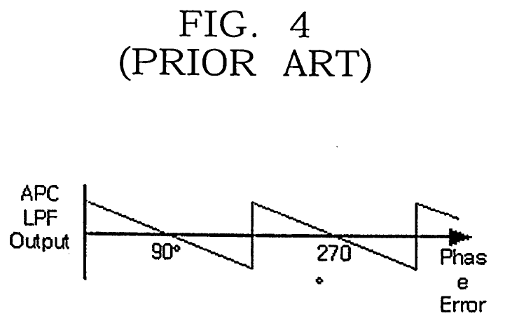

FIG. 5 is a block diagram illustrating a carrier frequency offset detecting apparatus in accordance with an embodiment of the present general inventive concept;

FIG. 6 is a diagram describing operation of the carrier frequency offset detecting apparatus illustrated in FIG. 5; and

FIG. 7 is a flowchart illustrating a method of detecting a frequency offset in accordance with an embodiment of the present general inventive concept.

### DETAILED DESCRIPTION OF THE PREFERRED EMBODIMENTS

Hereinafter, the present general inventive concept will be described in detail with reference to illustrative accompanying drawings.

In the following description, same drawing reference numerals are used for the same elements even in different drawings. The matters defined in the description such as a detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would obscure the general inventive concept in unnecessary detail.

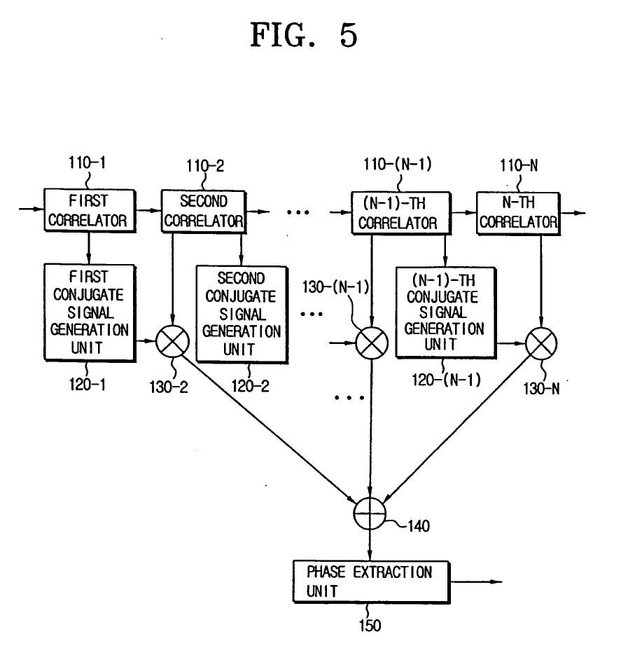

FIG. 5 is a block diagram illustrating an apparatus to detect a carrier frequency offset in accordance with an embodiment of the present general inventive concept. The carrier frequency offset detecting apparatus includes a first correlator 110-1 through an N-th correlator 110-N; a first conjugate signal generation unit 120-1 through an (N−1)-th conjugate signal generation unit 120-(N−1); a second multiplier 130-2 through an N-th multiplier 130-N; an adder 140; and a phase extraction unit 150. Herein, N is a positive number.

The first correlator 110-1 through the N-th correlator 110-N receive a field synchronization signal of a sampled input signal and calculate non-coherent correlation values. The non-coherent correlation values will be described later in greater detail.

The first conjugate signal generation unit 120-1 through the (N−1)-th conjugate signal generation unit 120-(N−1) are connected respectively with the first correlator 110-1 through the (N−1)-th correlator 110-(N−1) and, generate conjugate complex numbers corresponding to output signals of the first correlator 110 through the (N−1)-th correlator 110-(N−1).

The second multiplier 130-2 through the N-th multiplier 130-N multiply each of the output signals received from the correlators, i.e., the second correlator 110-2 through the N-th correlator 110-N, with each of the output signals from the first conjugate generation unit 120-1 through the (N−1)-th conjugate signal generation unit 120-(N−1), respectively.

The adder 140 adds the output signals of the second multiplier 130-2 through the N-th multiplier 130-N and calculates a cross correlation value. The cross correlation value will be described later.

The phase extraction unit 150 extracts a phase component, which is a carrier frequency offset, from an output value of the adder 140. Therefore, it is possible to detect the carrier frequency offset regardless of a symbol timing offset on the basis of the cross correlation and the non-coherent channel profile of the received field synchronization signal.

Meanwhile, when the calculated non-coherent correlation values become maximum, that is, on the basis of a main path, the phase component corresponding to the carrier frequency offset is extracted, or vectors of the cross correlation values are added which are determined to be greater than a predetermined threshold value. Then, a carrier frequency offset value corresponding to the added vector values is detected, thereby resulting in a highly accurate detection of the carrier frequency offset.

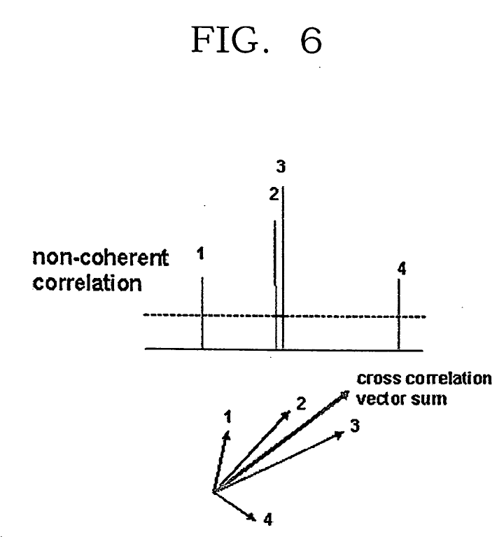

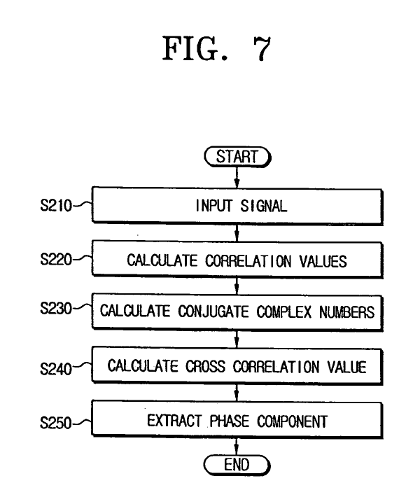

FIG. 6 is a diagram describing operation of the carrier frequency offset detecting apparatus illustrated in FIG. 5. FIG. 7 is a flowchart illustrating a method of detecting a carrier frequency offset in accordance with an embodiment of the present general inventive concept.

With reference to FIG. 7, a signal is inputted (operation S210). Then, to calculate a correlation value of the input signal, pseudo-noise (PN) sequences of a field synchronization signal are classified into N number of sub-sequences, and the first correlator 110-1 through the N-th correlator 110-N illustrated in FIG. 5 calculate the correlation value for each of the sub-sequences (operation S220).

In the field synchronization signal, M PN sequences classified into the N number of sub-sequences are expressed by Equation 1 as provided below:
p(n)=(p₁(n₁), p₂(n₂), . . . , pₙ(n_{N})
1≦n≦M
1≦nᵢ≦K(i=1, 2, . . . , N) Equation 1
where p(n) is the PN sequence classified into the N number of sub-sequences.

The input signal “r(k)” is defined by Equation 2 as provided below:
rᵢ(n)=pᵢ(n)e^{j(θ}^{₀}^{+((i-1)K+n)θ)}+nᵢ(n) Equation 2

Therefore, the first correlator 110-1 through the N-th correlator 110-N obtain the correlation values with respect to the input signal “r(k)” through the use of the sub-sequences “P(n).” The calculated correlation value is expressed by Equation 3 as provided below:

$${\sum }_{k = 1}^{k} {r}_{i} ( k ) {p}_{i} ( k ) , i = 1 , … , N \qquad Equation 3$$

Each of the first conjugate signal generation unit 120-1 through the (N−1)-th conjugate signal generation unit 120-(N−1) generate conjugate complex numbers for each of the correlation values calculated by the first correlator 110-1 through the (N−1)-th correlator 110-(N−1) connected with the first conjugate signal generation unit 120-1 through the (N−1)-th conjugate signal generation unit 120-(N−1), respectively (operation S230).

The second multiplier 130-2 through the N-th multiplier 130-N, respectively, multiply the above generated conjugate complex numbers calculated by the first conjugate signal generation unit 120-1 through the (N−1)-th conjugate signal generation unit 120-(N−1) with the correlation values calculated by the second correlator 110-2 through the N-th correlator 110-N. The adder 140 then performs a cumulative addition of the multiplication values obtained from the second multiplier 130-2 through the N-th multiplier 130-N, thereby obtaining a cross correlation value “C” defined by Equation 4 as provided below (operation S240):

$$C = {\sum }_{i = 1}^{N - 1} {\sum }_{n = 1}^{K} {r}_{i}^{*} ( n ) {p}_{i} ( n ) {r}_{i + 1} ( n ) {P}_{i + 1} ( n ) , \qquad Equation 4$$

where p(n) is the PN sequence classified into the N number of sub-sequences.

The phase extraction unit 150 extracts a phase component from the cross correlation value calculated by the adder 140 (operation S250). As mentioned above, the phase component corresponds to the carrier frequency offset. The cross correlation value output from the adder 140 is the correlation value of the conjugate complex numbers. The carrier frequency offset “CFO” calculated based on the cross correlation value is defined by Equation 5 as follows:

$$CFO = ∠ [ {\sum }_{i = 1}^{N - 1} {\sum }_{n = 1}^{K} {r}_{i}^{*} ( n ) {p}_{i} ( n ) {r}_{i + 1} ( n ) {P}_{i + 1} ( n ) ] \qquad Equation 5$$

That is, the carrier frequency offset “CFO” becomes a phase component “Kθ” of the cross correlation value.

Meanwhile, the moment of extrapolating the carrier frequency offset is when a channel profile value obtained through a partial non-coherent correlation operation becomes maximum. That is, the carrier frequency offset can be derived from calculating the cross correlation value on the basis of the main path. The partial non-coherent correlation operation can be expressed by Equation 6 provided below. Also, as illustrated in FIG. 6, the carrier frequency offset value can be detected through which the non-coherent correlation value derives a phase component value through a vector summation of the cross correlation values with respect to those passes exceeding a predetermined threshold value. In a case wherein the symbol timing recovery is incomplete, the use of the above described cross correlation vector summation method is preferable.

$${\sum }_{i = 1}^{N - 1} \vert {\sum }_{n = 1}^{K} {r}_{i} ( k ) {p}_{i} ( k ) \vert , \qquad Equation 6$$

where p(k) is the PN sequence classified into the N number of sub-sequences and r(k) is the input signal.

In accordance with an embodiment of the present general inventive concept, the carrier frequency offset is detected by using the cross correlation value of the field synchronization signal and the non-coherent channel profile regardless of the symbol timing recovery. Hence, it is advantageous that performance of a fine carrier frequency offset recovery connected to a rear terminal of the carrier frequency offset detecting apparatus is improved.

Also, the carrier frequency offset correction of a vestigial sideband signal is generally carried out by using a pilot signal. However, it is impossible to correct the carrier frequency offset when the pilot signal is damaged by a poor channel environment, and as a result, it is further impossible to receive a signal. In contrast, since a pilot signal is not employed in the present general inventive concept, the carrier frequency offset can be detected even in a poor channel environment.

Moreover, the channel profile can be read with high accuracy on the basis of the correlation values calculated through employing the PN sequences of the field synchronization signal, and thus, the carrier frequency offset detection apparatus can be normally operated even in a poor channel environment. The carrier frequency offset detection in accordance with an embodiment of the present general inventive concept is not affected by the symbol timing offset since the carrier frequency offset is detected through the vector summation of the cross correlation values at the moment when a channel profile that exceeds a predetermined threshold value at the non-coherent channel profile is generated.

The carrier frequency offset detecting apparatus of FIG. 5 can be applied as a synchronous detector that extrapolates synchronousness of a vestigial sideband (VSB) signal using a non-coherent correlation value, and other carrier frequency offset recovery algorithms that use a synchronous signal as a reference signal or a symbol timing recovery algorithm can be applied to the carrier frequency offset detecting apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to detect a carrier frequency offset, comprising:
a plurality of correlators to calculate individual correlation values by employing pseudo-noise (PN) sequences classified into a predetermined number of sub-sequences with respect to an input signal;
at least one conjugate signal generation unit to input individual output values of the correlators and then generate a conjugate complex number for each of the input values;
at least one multiplier to multiply the individual conjugate complex numbers output from the at least one conjugate signal generation unit with the individual output values of the neighbored correlators that do not input the correlation values to the at least one conjugate signal generation unit;
an adder to add output values of the at least one multiplier; and
a phase extractor to extract a phase component from an output value of the adder and to output the phase component as a carrier frequency offset.

2. The apparatus of claim 1, wherein the output value of the adder is defined as:
$${\sum }_{i = 1}^{N - 1} {\sum }_{n = 1}^{K} {r}_{i}^{*} {p}_{i} ( n ) {r}_{i + 1} ( n ) {P}_{i + 1} ( n ) ,$$
where r(n) is an input signal and p(n) is the PN sequence classified into the predetermined number of sub-sequences.

3. The apparatus of claim 2, wherein the input signal is defined in accordance with an equation as:
rᵢ(n)=pᵢ(n)e^{j(θ}^{₀}^{+((i-1)K+n)θ)}+nᵢ(n)

4. The apparatus of claim 1, wherein the plurality of correlators calculates the correlation values by employing the predetermined number of sub-sequences classified from the PN sequences and defined in accordance with an equation as:
p(n)=(p₁(n₁), p₂(n₂), . . . , pₙ(n_{N})
1≦n≦M
1≦nᵢ≦K(i=1, 2, . . . , N)
where p(n) is the PN subsequence classified into the predetermined number of sub-sequences.

5. The apparatus of claim 1, wherein the phase component extracted by the phase extractor is defined in accordance with an equation as:
$$CFO = ∠ [ {\sum }_{i = 1}^{N - 1} {\sum }_{n = 1}^{K} {r}_{i}^{*} ( n ) {p}_{i} ( n ) {r}_{i + 1} ( n ) {P}_{i + 1} ( n ) ]$$
where CFO is the carrier frequency offset.

6. The apparatus of claim 1, wherein the phase extractor extracts the phase component from a vector summation of the output values of the adder for paths exceeding a predetermined threshold value by employing a channel profile based on a non-coherent correlation value obtained with use of the correlation values outputted from the plurality of correlators.

7. The apparatus of claim 1, wherein the phase extractor extracts the phase component from the output value of the adder corresponding to a main path by employing a channel profile based on a non-coherent correlation value obtained with use of the correlation values outputted from the plurality of correlators.

8. The apparatus of claim 6 or 7, wherein the non-coherent correlation value is defined in accordance with an equation as:
$${\sum }_{i = 1}^{N - 1} \vert {\sum }_{n = 1}^{K} {r}_{i} ( k ) {p}_{i} ( k ) \vert$$
where p(k) is the PN sequence, and r(k) is the input signal.

9. A method of detecting a carrier frequency offset, comprising:
calculating individual correlation values by employing PN sequences classified into a predetermined number of sub-sequences with respect to an input signal;
generating individual conjugate complex numbers for the individual correlation values output from distally disposed parts among the calculated correlation values;
multiplying the individual conjugate complex numbers with the individual correlation values output from proximally disposed parts among the calculated correlation values;
adding the multiplied values, thereby obtaining a cross correlation value; and
extracting a phase component from the cross correlation value and outputting the phase component as a carrier frequency offset.

10. The method of claim 9, wherein the cross correlation value is defined in accordance with an equation as:
$${\sum }_{i = 1}^{N - 1} {\sum }_{n = 1}^{K} {r}_{i}^{*} ( n ) {p}_{i} ( n ) {r}_{i + 1} ( n ) {P}_{i + 1} ( n )$$
where r(n) is the input signal and p(n) is the PN sequence classified into the predetermined number of sub-sequences.

11. The method of claim 10, wherein the input signal is defined in accordance with an equation as:
rᵢ(n)=pᵢ(n)e^{j(θ}^{₀}^{+((i-1)K+n)θ)}+nᵢ(n)

12. The method of claim 9, wherein at the operation of calculating the correlation values, the correlation values are calculated by employing individual sub-sequences classified from the PN sequences and defined in accordance with an equation as:
p(n)=(p₁(n₁), p₂(n₂), . . . , pₙ(n_{N})
1≦1≦M
1≦nᵢ≦K(i=1, 2, . . . , N)
where p(n) is the PN sequence classified predetermined number of the sub-sequences.

13. The method of claim 9, wherein at the operation of outputting the carrier frequency offset, the phase component is extracted in accordance with an equation as:
$$CFO = ∠ [ {\sum }_{i = 1}^{N - 1} {\sum }_{n = 1}^{K} {r}_{i}^{*} ( n ) {p}_{i} ( n ) {r}_{i + 1} ( n ) {P}_{i + 1} ( n ) ]$$
where CFO is the carrier frequency offset.

14. The method of claim 9, wherein at the operation of outputting the carrier frequency offset, the phase component is extracted through a vector summation of the cross correlation values for paths exceeding a predetermined threshold value by using a channel profile based on a non-coherent correlation value obtained with use of the correlation values.

15. The method of claim 9, wherein at the operation of outputting the carrier frequency offset, the phase extractor extracts the phase component from the cross correlation value corresponding to a main path by employing a channel profile based on a non-coherent correlation value obtained with use of the correlation values.

16. The method of claim 14, wherein the non-coherent correlation value is defined in accordance with an equation as:
$${\sum }_{i = 1}^{N - 1} \vert {\sum }_{n = 1}^{K} {r}_{i} ( k ) {p}_{i} ( k ) \vert$$
where p(k) is the PN sequence classified into the predetermined number of sub-sequences and r(k) is the input signal.

17. The method of claim 15, wherein the non-coherent correlation value is defined in accordance with an equation as:
$${\sum }_{i = 1}^{N - 1} \vert {\sum }_{n = 1}^{K} {r}_{i} ( k ) {p}_{i} ( k ) \vert$$
where p(k) is the PN sequence classified into the predetermined number of sub-sequences and r(k) is the input signal.

18. A carrier frequency offset detection apparatus, comprising:
a plurality of correlators in series, each correlator calculates a non-coherent correlation value from an input field synchronization signal;
a plurality of conjugate signal generation units, each conjugate signal generation unit being connected to a respective one of the plurality of correlators to generate conjugate complex numbers corresponding to output signals of the respective correlator;
a plurality of multipliers, each multiplier to multiply an output signal from a respective one of the plurality of correlators with an output of a respective one of the plurality of conjugate signal generation units connected to the respective correlator;
an adder that adds the outputs of the plurality of multipliers and calculates a cross correlation value; and
a phase extraction unit that extracts a phase component of the calculated cross correlation value, which is a carrier frequency offset.

19. The carrier frequency offset detection apparatus of claim 19, wherein when the calculated non-coherent correlation values become maximum, vectors of the cross correlation values are added which are greater than a predetermined threshold value, and then a carrier frequency offset value corresponding to the added vector value is detected.

20. The carrier frequency offset detection apparatus of claim 19, wherein the plurality of correlators each calculate a correlation value by classifying pseudo-noise sequences of the field synchronization signal into N number of sub-sequences and then calculating the correlation value for each of the sub-sequences.

21. The carrier frequency offset detection apparatus of claim 20, wherein M pseudo-noise sequences classified into the N number of sub-sequences are expressed by
p(n)=(p₁(n₁), p₂(n₂), . . . , pₙ(n_{N})
1≦1≦M
1≦nᵢ≦K(i=1, 2, . . . , N)
where p(n) is the pseudo-noise sequence classified into the N number of sub-sequences.

22. A carrier frequency offset detection apparatus, comprising:
a plurality of conjugate signal generation units that each generate conjugate complex numbers corresponding to input individual correlation values generated by using pseudo-noise sequences classified into a predetermined number of sub-sequences with respect to a field synchronization signal;
a multiplier associated with each conjugate signal generation unit to multiply an output of the associated conjugate signal generation unit with the corresponding input correlation value of the conjugate signal generation unit;
an cross correlation calculation unit that calculates a cross correlation value from the output of the multipliers; and
a phase extraction unit that extracts a phase component of the cross correlation value, which is a carrier frequency offset.

23. A method of detecting a carrier frequency offset, comprising:
generating conjugate complex numbers corresponding to input individual correlation values generated by using pseudo-noise sequences classified into a predetermined number of sub-sequences with respect to a field synchronization signal;
multiplying each of the conjugate complex numbers generated with the corresponding input correlation value;
calculating a cross correlation value from the multiplied values; and
extracting a phase component of the cross correlation value and outputting the phase component as a carrier frequency offset.
